(19) United States
(12) Patent Application Publication
(10) Pub. No.: US 2013/0250140 A1
(43) Pub. Date: Sep. 26, 2013

(54) COMPOSITE MEMORY CARD AND DEDICATED READER

(71) Applicant: En-Min Jow, Hsinchu (TW)

(72) Inventor: En-Min Jow, Hsinchu (TW)

(73) Assignee: APTOS TECHNOLOGY INC., Hsinchu County (TW)

(21) Appl. No.: 13/429,453

(22) Filed: Mar. 26, 2012

(51) Int. Cl. H04N 5/225; G10L 19/00

(52) U.S. Cl. 348/231.4; 704/201; 704/E19.001; 348/E05.024

(57) ABSTRACT

A composite memory card has 4-bit and 1-bit data transfer modes; in which, when the composite memory card plugs in a general reader, it operates in the 4-bit data transfer mode to form 4-bit format information signal linking with the external transfer through four data pins; and when it plugs in a dedicated reader, it operates in the 1-bit data transfer mode to form 1-bit format data signal linking with the external transfer through one data pin, while it starts the internal audio processing module to read the internal audio file streaming and to transform into voice output signal output to the dedicated reader through the other data pins for broadcast, and to receive the voice input signal of the dedicated reader through data pins to transform into audio file streaming to import for storage; thus, the composite memory card combines the standard memory card and the audio processing function.

### BACKGROUND OF THE INVENTION

(a) Field of the Invention

The present invention relates to a memory card, specifically to a composite memory card and dedicated reader combining the standard memory card and the audio processing function.

(b) Description of the Prior Art

The fresh memory card adopting fresh memory to store data is widely used in various types of electronic devices. As the rapid evolution of digital devices, many types of memory card specifications are also launched to match the device. Recently the mainstream memory card (SD/MMC/MS) are launched with new miniaturized size, for example, the SD memory card (Secure digital card) includes standard SD, Mini SD and Micro SD series specifications.

In addition to miniature packages, the memory card data transfer mode evolves at the same time, for example: SD series memory card with 1-bit and 4-bit data transfer modes, and MMC series memory card with 1-bit, 4-bit and 8-bit data transfer modes. Multi-bit parallel signal transfer will substantially improve the data transfer rates, and still has the serial signal transfer mode to match the application side device.

The signal pins of the memory card are arranged on the basis of standard specification, in which the SD memory card with 1-bit and 4-bit data transfer modes is installed with four data pins for connecting the 4-bit signal channel with the external device. However, when the memory card operates in 1-bit data transfer mode, only one data pin is used for transmitting data signals, and the other data pins are in the idle state, which is an available resource, but is not used by the memory card products until now.

Currently, the application scope of the memory card is continuously expanded, however, its function is still limited by basic data storage. The industrial more puts emphasis on only data access optimization and data security improvement for the memory card, while rare functional innovation and breakthrough. In view of this, the inventor provides the standard memory card with new function to escape from its data storage one use.

### SUMMARY OF THE INVENTION

The main object of the present invention is to provide a composite memory card, which has 4-bit and 1-bit data double data transfer modes, and internal integrated audio processing function, when it operates in 1-bit data transfer mode, the audio processing module is started to use the other data pins to transmit voice signals, thus it combines the standard memory card and the audio processing function, and expands the memory card use.

The secondary object of the present invention is to provide a dedicated reader, through the dedicated reader, an enabled signal is output to start the composite memory card to implement the audio processing function, which applies to device recognition and certification, to achieve data security function.

The still object of the present invention is to provide a dedicated reader, through the audio function module of the dedicated reader, the audio is directly broadcasted, received and recorded, to improve the convenience of user end.

The present invention disclose a composite memory card, according to the standard memory card specification, which has a 4-bit data transfer mode and a 1-bit data transfer mode. The composite memory card includes a communication interface, a memory module, a control system and an audio processing module.

The communication interface has a control pin and four data pins. The memory module is used for data storage. The control system detects the signal input by the control pin, to determine whether operates in 4-bit data transfer mode or 1-bit data transfer mode. The control system includes a data processing module and an audio processing module, when operating in the 4-bit data transfer mode, the data processing module forms a 4-bit format data signal linking with the external transfer through the four data pins. When operating in the 1-bit data transfer mode, the data processing module forms a 1-bit format data signal linking with the external transfer through one of the four data pins. The audio processing module is started in the 1-bit data transfer mode, in which the memory module reads an audio file streaming transformed into and output a pair of voice output signals, and receives a voice input signal transformed into an audio file streaming to be imported to the memory module for storage, and the pair of the voice output signals and the voice input signal link with the external transfer through the other three data pins of the four data pins.

As for a specific embodiment, the control system further includes a channel switch module and a mode control module; in which the channel switch module has a fixed channel and three variable channels, one end of each of the fixed channel and the three variable channels individually couples to the four data pins, another end of the fixed channel couples to the data processing module, and another end of each of the three variable channels optionally and simultaneously couple to the data processing module, or simultaneously couple to the voice processing module; and the mode control module detects the signal input by the control pin, to determine that the control system operates in the 4-bit data transfer mode, to control the data processing module to form the 4-bit format data signal, and to control the three variable channels to be coupled between the communication interface and the data processing module, or to determine that the control system operates in the 1-bit data transfer mode, to further control the data processing module to form the 1-bit format data signal, to start the audio processing module, and to control the three variable channels to be coupled between the communication interface and the audio processing module.

The present invention further discloses a dedicated reader applying to the composite memory card. The dedicated reader includes a slot, a control module, a transmission interface and an audio function module. The structure of the slot coordinates to be plugged by the composite memory card. The control module is used for producing and outputting an enabled signal, wherein the enabled signal is used for starting the composite memory card to operate in the 1-bit data transfer mode. The transmission interface is installed within the slot to connect with the communication interface of the composite memory card, wherein the transmission interface couples to the control module to input the enabled signal to the control pin of the composite memory card, and connects with the composite memory card through the four data pins to transmit the 1-bit format data signal, the pair of the voice output signals and the voice input signal. The audio function module includes a broadcast unit and a radio unit, wherein the audio function module is controlled by the control module, broadcasts the pair of the voice output signals through the broadcast unit, and forms the voice input signal through the radio unit receiving and recording the external voice.

The above description and the following detailed explanation and drawings are all for further describing the ways, means and effects adopted for achieving the predetermined object of the present invention. The other objects and advantages of the present invention will be described in the following explanation and drawings.

### BRIEF DESCRIPTION OF THE DRAWINGS

FIG. 1 is a schematic view showing the system architecture of a specific embodiment of the composite memory card of the present invention;

FIG. 2 is a schematic view showing the appearance of a specific embodiment of the dedicated reader of the composite memory card of the present invention;

FIGS. 3A and 3B are schematic views showing the operations of the channel switch module of the present invention;

FIG. 4 is a schematic view showing the appearance of a specific embodiment of the dedicated reader of the composite memory card of the present invention;

FIG. 5 is an exploded view of a specific embodiment of the dedicated reader of the composite memory card; and

FIG. 6 is a schematic view showing the system architecture of a specific embodiment of the dedicated reader of the composite memory card of the present invention.

### DESCRIPTION OF MAIN COMPONENT SYMBOLS

10: Composite memory card

100, 300: Shell

11: Communication interface

110: Control pin

11a, 11b, 11c, 11d: Data pin

13: Control system

131: Mode control module

132: Audio processing module

133: Data processing module

134: Channel switch module

134a, 134b, 134c, 134d: Channel

15: Memory module

20: Reading system

30: Dedicated reader

301: Slot

302: Circuit board assembly

303: Display panel

304: Audio functional component

305: Transmission port

31: Transmission interface

32: Control module

33: Operation module

34: Audio function module

341: Broadcast unit

342: Radio unit

35: Display module

36: Transmission module

### DETAILED DESCRIPTION OF THE PREFERRED EMBODIMENTS

The present invention provides a composite memory card and dedicated reader, and the main features are that the composite memory card combines the standard memory card and the audio processing function; when the composite memory card is plugged in a general reader, it operates in the 4-bit data transfer mode, and when it is plugged in a dedicated reader, it operates in the 1-bit data transfer mode, starts the internal audio processing function, and uses the other data pins to transmit the voice signals.

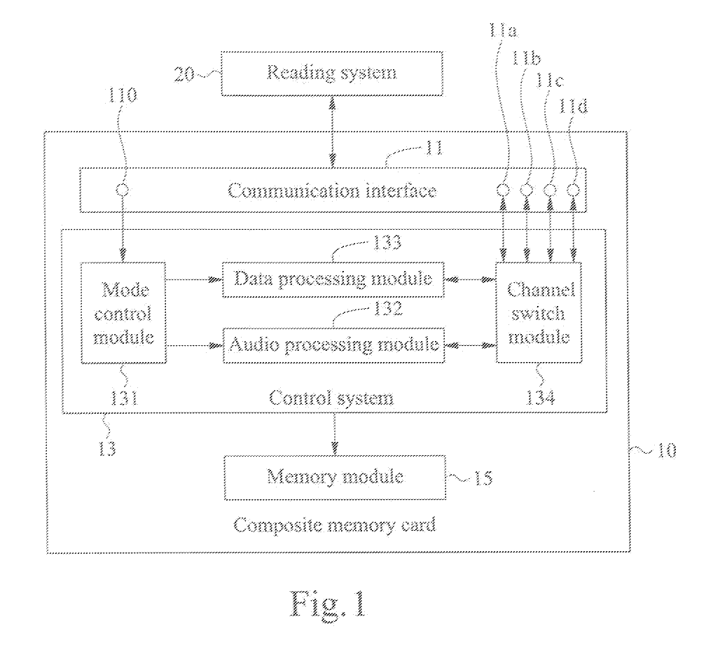

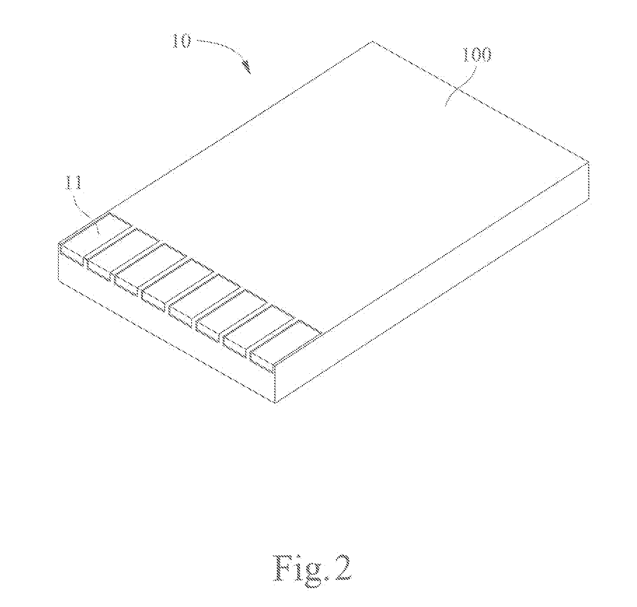

First, referring to FIGS. 1 and 2, which are schematic views showing the system architecture and the appearance of a specific embodiment of the composite memory card of the present invention, respectively. As shown in the drawings, a composite memory card 10 includes a shell 100, a communication interface 11, a control system 13 and a memory module 15.

The composite memory card 10, on the basis of a standard memory card specification, has 1-bit and 4-bit double data transfer modes. In the memory card specification, the SD series memory card and the MMC series memory card both have 1-bit and 4-bit data transfer modes, thus the specification of the composite memory card 10 is selected to use the SD memory card or the MMC memory card.

The communication interface 11 is jointly formed by plural signal pins with the gold finger pattern, and exposes to the shell 100 to be electrically coupled to a reading system 20. The pins of the communication interface 11 are arranged on the basis of the standard specification, include a control pin 110 and four data pins 11a, 11b, 11c and 11d. The control pin 110 is used for receiving a control signal input by the reading system 20, and the composite memory card 10 recognizes the signal and determines the data transfer mode used.

The control system 13 and the memory module 15 are covered within the shell 100. The memory module 15 is constituted by non-volatile memory (such as fresh memory) and used for data storage. The control system 13 couples between the communication interface 11 and the memory module 15, and is controlled by the reading system 20 through the communication interface 11 to access the memory module 15. The control system 13 includes a mode control module 131, an audio processing module 132, a data processing module 133 and a channel switch module 134.

The mode control module 134 detects the signal input by the control pin 110, and then determines whether to operate in the 4-bit data transfer mode or to operate in the 1-bit data transfer mode. When the external reading system 20 is a general reader, a general controlled signal is input, the mode control module 134 recognizes the controlled signal, and makes the control system 13 to switch to operate in the 4-bit data transfer mode. When the external reading system 20 is a dedicated reader, a specific enabled signal is input, the mode control module 134 recognizes the controlled signal, and makes the control system 13 to switch to operate in the 1-bit data transfer mode.

The data processing module 133 is used for forming data signals, when operating in the 4-bit data transfer mode, it is controlled by the mode control module 131 to form the 4-bit format data signal linking with the reading system 20 transfer through the data pins 11a, 11b, 11c and 11d, and when operating in the 1-bit data transfer mode, it is controlled by the mode control module 131 to form the 1-bit format data signal (linking with the external transfer through a data pin.

The mode control module 131 starts the audio processing module 132 in the 1-bit data transfer mode. The audio processing module 132 has the audio encoding/decoding function, in which the memory module 15 reads an audio file streaming to be decoded, and to be transformed into and output a pair of dual-channel voice output signal, and receives a voice input signal to be encoded, and to be transformed into an audio file streaming to import to the memory module 15 for storage, in which the pair of the voice output signals and the voice input signal link with the external reading system 20 transfer through the other three data pins of the four data pins.

The channel switch module 134 couples among the communication interface 11, the data processing module 133 and the audio processing module 132, and is controlled by the mode control module 131 to switch the signal channel. When operating in the 4-bit data transfer mode, the data processing module 133 couples to the four data pins 11a, 11b, 11c and 11d, to provide a 4-bit signal channel; and when operating in the 1-bit data transfer mode, the data processing module 133 couples to a data pin, to provide a 1-bit signal channel, and couples to the other three data pins, to transmit the pair of the voice output signals and the voice input signal.

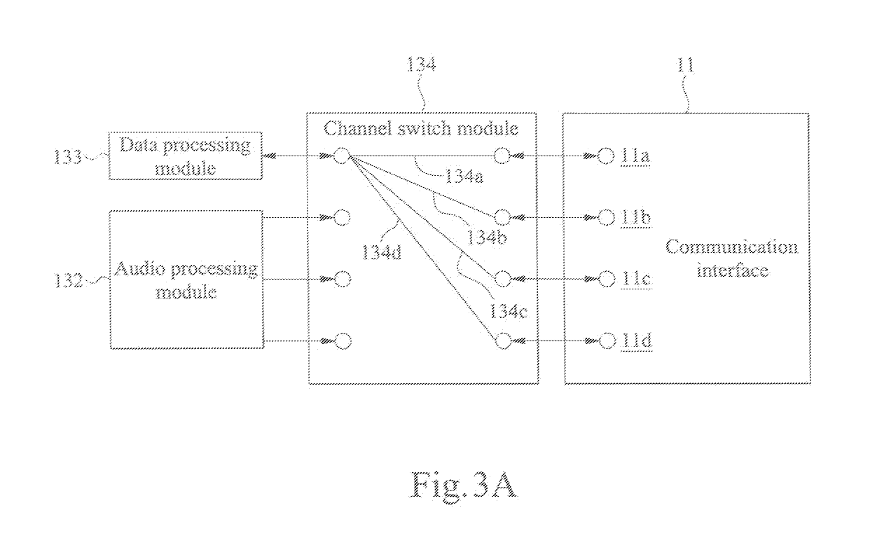

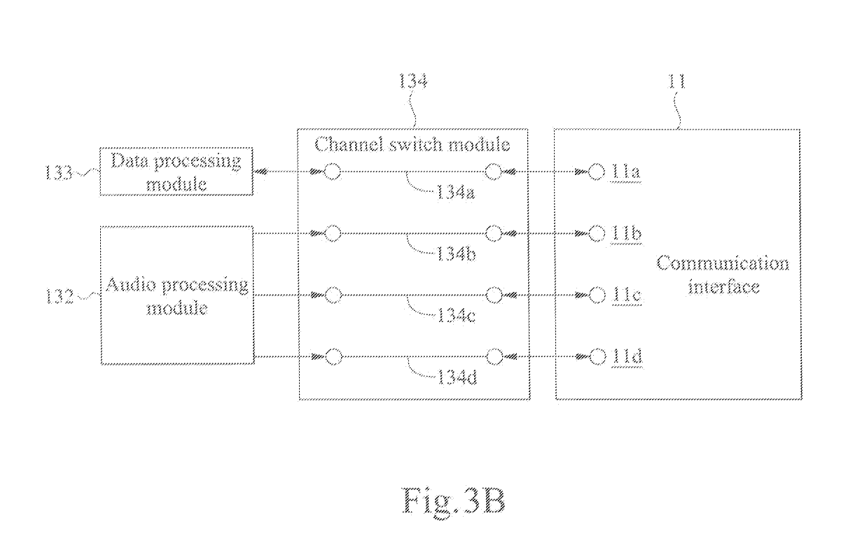

Next, the channel switch module 134 is further explained, referring to FIGS. 3A and 3B, which are schematic views showing the operations of the channel switch module 134 of the present invention. In the drawings, the channel switch module 134 has four transmission channels 134a, 134b, 134c and 134d, in which the channel 134a is a fixed channel coupling between the data pin 11a of the communication interface 11 and the data processing module 133. The channels 134b, 134c and 134d are variable channels, one ends of them fixedly couple to the data pins 11b, 11c and 11d of the communication interface 11, and the other ends optionally and simultaneously couple to the data processing module 133, or simultaneously couple to the audio processing module 132.

FIG. 3A shows the standard memory card mode, in which the data processing module 133 operates in the 4-bit data transfer mode, and the channels 134a, 134b, 134c and 134d couple between the communication interface 11 and the data processing module 133, and provide a 4-bit signal channel for the 4-bit format data signal passing through.

FIG. 3B shows the audio processing mode, in which the channel 134a provides a 1-bit signal channel for the 1-bit format data signal passing through, and the other channels 134b, 134c and 134d are for the pair of the voice output signals and the voice input signal passing through.

The control system 13, by way of the control of the microcontroller and the logic resources, is implemented through the designed specific firmware, in which the channel switch module 134 implements the function thereof through a crossbar switch.

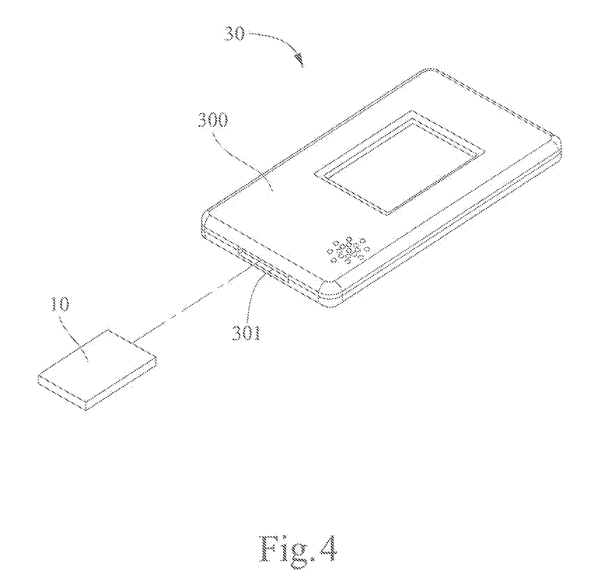

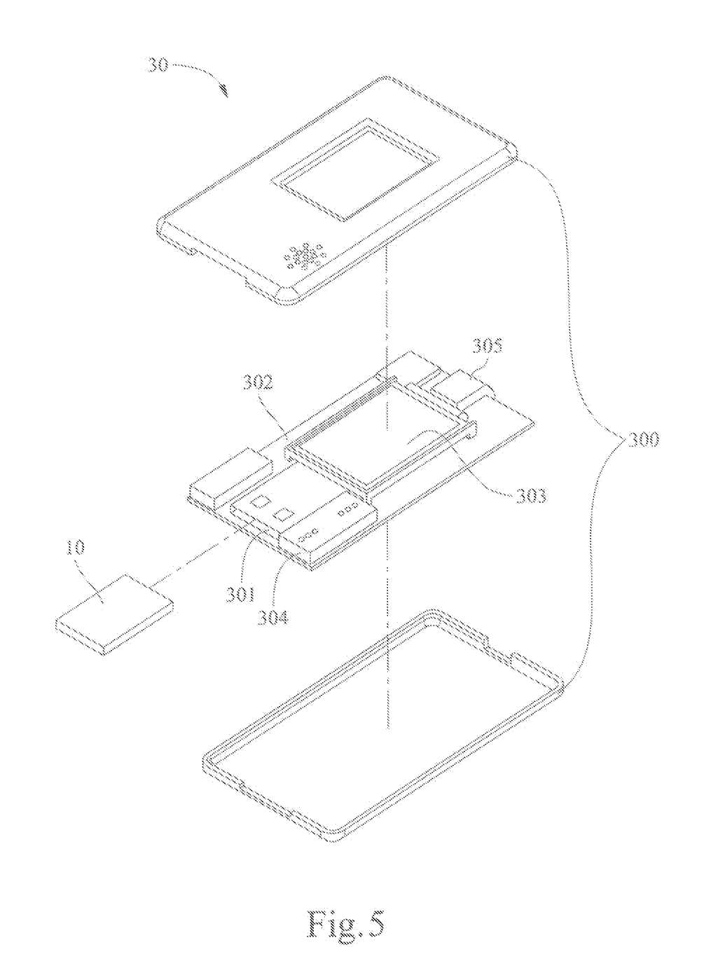

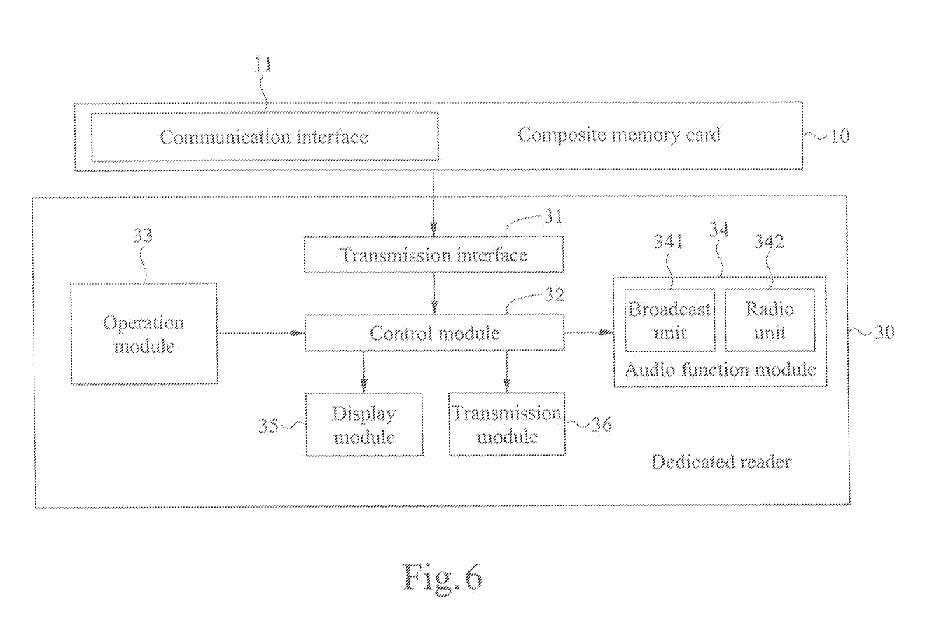

Referring to FIGS. 4 to 6, which are schematic appearance view, exploded view and system architecture view showing a specific embodiment of the dedicated reader of the composite memory card of the present invention, respectively, the dedicated reader of the composite memory card is still explained. The dedicated reader 30 has a shell 300 and a slot 301, in which the slot 301 integrates with the shell 300, and the structure thereof coordinates to be plugged by the composite memory card 10 accordingly controlled to operate in the 1-bit data transfer mode to start the audio processing function. The dedicated reader 30 coordinates to broadcast the voice output signal, and receive and record the external voice to form the voice output signal. The dedicated reader 30, coordinating to implement the audio broadcast and the receiving and recording function, has a transmission interface 31, a control module 32, an audio function module 34 and an operation module 33.

The transmission interface 31 is installed within the slot 301 for connecting with the communication interface 11 of the composite memory card 10, to be electrically coupled to the control pin 110 and the data pins 11a, 11b, 11c and 11d. The control module 32 is used for producing and outputting an enabled signal applying to starting the composite memory card 10 to operate in the 1-bit data transfer mode.

By the way, the identification of the enabled signal of the dedicated reader 30 can be applied to the digital content security. The composite memory card 10, only under the condition of detecting the enabled signal, authorizes to read the internal file streaming, and general readers cannot read the digital audio content within the composite memory card 10.

The transmission interface 31 couples to the control module 32, inputs the enabled signal to the control pin 110 of the composite memory card 10, and links with the composite memory card 10 through the four data pins 11a, 11b, 11c and 11d, to transmit the 1-bit format data signal, the pair of the voice output signals and the voice input signal. The audio function module 34 includes a broadcast unit 341 and a radio unit 342, in which the broadcast unit 341 and the radio unit 342 are speaker and microphone, respectively, and the audio function module 34 is controlled by the control module 32, through the broadcast unit 341 broadcasting the pair of the voice output signals and the radio unit 342 receiving and recording the external voice, to form the voice input signal. The operation module 33 integrates with the shell 300, and couples with the control module 32, to accept the external operations for further producing an operation signal transmitted to the control module 32. The operation module 33 is an operation component, such as switch, button, key, touchpad, etc, and the control module 32 controls the audio playback volume and audio types, according to the operation signal.

In the embodiment, the dedicated reader 30 further includes a display module 35, which is integrated with the shell 300, couples to the control module 32, and displays under the control of the control module 32 to assist users to operate the device. The display module 35 is a light-emitting component or monitor, such as light-emitting diode. The dedicated reader 30 further includes a transmission module 36, which is integrated with the shell 300, and couples to the control module 32, for indirectly or directly coupling to an external system (such as computer), to further read out and write in the composite memory card 10 through the external system. The transmission module 36 includes an Universal Serial Bus (USB) transmission port and/or a Firewire (IEEE 1394) transmission port.

In another embodiment, dedicated reader 30 includes an image processing module and an image capture device installed at the shell 300, to capture the external image, which is processed by the image processing module to a data signal, and controlled by the control module 32 to import to the memory module 15 of the composite memory card 10 for storage.

In still another embodiment, the dedicated reader 30 includes an image processing module and a display panel, wherein the control module 32 reads an AV file stored in the memory module 15 of the composite memory card 10, which is processed by the image processing module, and then displayed by the monitor.

The control module 32 adopts a proper microcontroller designing internal firmware to implement the specific function thereof. The individual modules of the dedicated reader 30 are integrated to a circuit board assembly 302 and the equipped slot 301, display panel 303, audio functional component 304 and transmission port 305, to be installed at the specific locations of the shell 300, in which the audio functional component 304 integrates with the broadcast unit 341 and the radio unit 342. Furthermore, the dedicated reader 30 further includes a power module to be installed with rechargeable batteries or ordinary batteries to provide the internal operation power, and to power the composite memory card 10 through the communication interface 11. We can flexibly arrange the various additional functions for the dedicated reader 30, according to the client operating fitness and performance requirements, with the control firmware design to achieve device anticipate function.

From the above, the composite memory card of the present invention combines the standard memory card and the audio processing function, which will expand the application level of the memory card, and improve the convenience of the client through the dedicated reader broadcasting, receiving and recording the audio, in addition, the dedicated reader outputs the enabled signal to start the audio processing function of the composite memory card, which can be applied to device recognition and certification to achieve the data security function.

The above-mentioned are detailed explanations and drawings of specific embodiments of the present invention, which are not used for limiting the present invention, the scope of the present invention falls within the following claims, and the changes and modifications easily understood by every skilled in the art are covered within the scope of the present invention.

1. A composite memory card, according to standard memory card specification, which has 4-bit data transfer mode and 1-bit data transfer mode, in which, the composite memory card includes:
a communication interface, containing one control pin and four data pins;
a memory module for storing data; and
a control system for detecting the signal input by the control pin, to determine to operate in the 4-bit data transfer mode of the 1-bit data transfer mode, the control system including:
a data processing module, in which when operating in the 4-bit data transfer mode, the data processing module forms a 4-bit format data signal linking with the external transfer through four data pins, and when operating in the 1-bit data transfer mode, the data processing module forms a 1-bit format data signal linking with the external transfer through one of the four data pins;
an audio processing module, which is started when operating in the 1-bit data transfer mode, in which the memory module reads an audio file streaming and transforms into a pair of voice output signals to output, and receives a voice input signal and transforms into an audio file streaming to import the memory module for storage;
wherein the pair of the voice output signals and the voice input signal link with the external transfer through the other three data pins of the four data pins.

2. The composite memory card as claimed in claim 1, in which the control system further includes:
a channel switch module, including a fixed channel and three variable channels, wherein one end of each of the fixed channel and the three variable channels individually couples to the four data pins, another end of the fixed channel couples to the data processing module, and another end of each of the three variable channels optionally and simultaneously couple to the data processing module, or simultaneously couple to the voice processing module; and
a mode control module, for detecting the signal input by the control pin, to determine that the control system operates in the 4-bit data transfer mode, to control the data processing module to form the 4-bit format data signal, and to control the three variable channels to be coupled between the communication interface and the data processing module, or to determine that the control system operates in the 1-bit data transfer mode, to further control the data processing module to form the 1-bit format data signal, to start the audio processing module, and to control the three variable channels to be coupled between the communication interface and the audio processing module.

3. The composite memory card as claimed in claim 1, in which the specification of the standard memory card is the specification of SD memory card or MMC memory card.

4. A dedicated reader applying to the composite memory card as claimed in claim 1, in which the dedicated reader includes:
a slot, with the structure coordinating to be plugged by the composite memory card;
a control module, for producing and outputting an enabled signal, wherein the enabled signal is used for starting the composite memory card to operate in the 1-bit data transfer mode;
a transmission interface, installed within the slot to connect with the communication interface of the composite memory card, wherein the transmission interface couples to the control module to input the enabled signal to the control pin of the composite memory card, and connects with the composite memory card through the four data pins to transmit the 1-bit format data signal, the pair of the voice output signals and the voice input signal; and
an audio function module, including a broadcast unit and a radio unit, wherein the audio function module is controlled by the control module, broadcasts the pair of the voice output signals through the broadcast unit, and forms the voice input signal through the radio unit receiving and recording the external voice.

5. The dedicated reader as claimed in claim 4, further including a shell to coordinate to integrate the slot, the control module, the transmission interface and the audio function module.

6. The dedicated reader as claimed in claim 5, further including an operation module to be integrated at the shell, to couple to the control module to be externally controlled, and to further produce an operation signal to be output to the control module, wherein the operation module includes an operation component selected from a group composed of a switch, a button, a key and a touchpad, or any combination thereof.

7. The dedicated reader as claimed in claim 6, further including a display module to be integrated at the shell, to couple to the control module to be controlled by the control module for display, wherein the display module includes a display component selected from a group composed of a light-emitting component and a display panel, or the combination of such display component.

8. The dedicated reader as claimed in claim 6, further including a transmission module to be integrated at the shell, to couple to the control module to be coupled to an external system, wherein the transmission module is a transmission port selected from a group composed of an Universal Serial Bus (USB) transmission port and a Firewire (IEEE 1394) transmission port, or the combination of such transmission port.

9. The dedicated reader as claimed in claim 6, further including an image processing module, wherein the image processing module has an image capture device integrated at the shell, to capture the external image, which is processed by the image processing module to a data signal, and controlled by the control module to import to the memory module of the composite memory card for storage.

10. The dedicated reader as claimed in claim 6, further including an image processing module and a monitor, wherein the control module reads an AV file of the memory module of the composite memory card, which is processed by the image processing module, and then displayed by the monitor.
